(19) United States
(12) Patent Application Publication
(10) Pub. No.: US 2003/0212625 A1
(43) Pub. Date: Nov. 13, 2003

(54) Summary scan layout

(76) Inventors: Peter J. Martyn, Ridgewood, NJ (US); Natalya Okunev, Brooklyn, NY (US)

Correspondence Address: DENIS G. MALONEY, Fish & Richardson P.C., 225 Franklin Street, Boston, MA, 02110-2804, US

(21) Appl. No.: 10/295,012

(22) Filed: Nov. 14, 2002

Related U.S. Application Data
(60) Provisional application No. 60/335,388, filed on Nov. 14, 2001.
(60) Provisional application No. 60/385,979, filed on Jun. 5, 2002.
(60) Provisional application No. 60/385,988, filed on Jun. 5, 2002.

(51) Int. Cl. G06F 17/60

(52) U.S. Cl. 705/37; 705/36

(57) ABSTRACT

A summary display process includes a securitiy selection process for selecting a specific security traded on a securities market. A price range specification process specifies a desired price range for that specific security. An ask-side aggregated display process displays, in a multi-column format, an ask-side entry for the specific security that is offered for sale by at least one market participant on the securities market. This ask-side entry includes an ask price, a lot size, and an ask-side aggregate value. A bid-side aggregated display process displays, in a multi-column format, a bid-side entry for the specific security that is wanted for purchase by at least one market participant on the securities market. This bid-side entry includes a bid price, a lot size, and a bid-side aggregate value, and the bid-side aggregated display process is configured to display the bid-side entry such that it is essentially a mirror image of the ask-side entry.

### RELATED APPLICATIONS

This application claims the priority of U.S. Provisional Patent Application No. 60/335,388, entitled “Super Montage”, and filed on Nov. 14, 2001.

The following applications are hereby incorporated by reference into the subject application as if set forth herein in full: (1) U.S. application Ser. No. 09/401,875, filed Sep. 23, 1999, entitled “Montage For Automated Market System” (Atty. Docket No. 09857-023001); (2) U.S. application Ser. No. 09/401,872, filed Sep. 23, 1999, entitled “Montage For Automated Market System” (Atty. Docket No. 09857-027001); and (3) U.S. application Ser. No. 09/569,524, filed May 12, 2000, entitled “Montage For An Electronic Market” (Atty. Docket No. 09857-035001).

### BACKGROUND

This invention relates to electronic securities trading, and the processing and displaying of information relating to electronic securities trading.

Electronic equity markets, such as The Nasdaq Stock Market™ collect, aggregate, and display pre-trade information to market makers. In the Nasdaq Stock Market, for example, this pre-trade information takes the form of a quote that represents a single or an aggregate of same-priced principal or agency orders. A market, such as The Nasdaq Stock Market™, also provides trading platforms through which market makers may trade securities in the marketplace.

### SUMMARY

According to an aspect of this invention, a summary display process includes a securitiy selection process for selecting a specific security traded on a securities market. A price range specification process specifies a desired price range for that specific security. An ask-side aggregated display process displays, in a multi-column format, an ask-side line item for the specific security that is offered for sale by at least one market maker on the securities market. This ask-side line item includes an ask price, a lot size, and an ask-side aggregate value. A bid-side aggregated display process displays, in a-multi-column format, a bid-side line item for the specific security that is wanted for purchase by at least one market maker on the securities market. This bid-side line item includes a bid price, a lot size, and a bid-side aggregate value,

One or more of the following features may also be included. The ask-side aggregated display process includes a tabular display process for simultaneously displaying multiple ask-side entries in an ask-side table. The ask-side aggregated display process includes a tabular sorting process for sorting the multiple ask-side entries in accordance with a user-defined sorting parameter, such as the lot size or the ask price. An ask-side aggregate calculation process generates the ask-side aggregate value for a specific ask-side entry, such that the ask-side aggregate value is equal to the lot size of the specific ask-side entry summed with the lot sizes of all preceding ask-side entries included in the ask-side table.

The bid-side aggregated display process includes a tabular display process for simultaneously displaying multiple bid-side entries in a bid-side table. The bid-side aggregated display process includes a tabular sorting process for sorting the multiple bid-side entries in accordance with a user-defined sorting parameter, such as the lot size, or the bid price. A bid-side aggregate calculation process generates the bid-side aggregate value for a specific bid-side entry, such that the bid-side aggregate value is equal to the lot size of the specific bid-side entry summed with the lot sizes of all preceding bid-side entries included in the bid-side table.

A display deactivation process deactivates one of the ask-side aggregated display process and the bid-side aggregated display process.

According to a further aspect of this invention, a summary display method includes selecting a specific security traded on a securities market. A desired price range is specified for the specific security. An ask-side entry is displayed, in a multi-column format, for the specific security that is offered for sale by at least one market participant on the securities market. This ask-side entry includes an ask price, a lot size, and an ask-side aggregate value. A bid-side entry is displayed, in a multi-column format, for the specific security that is wanted for purchase by at least one market participant on the securities market. This bid-side entry, which includes a bid price, a lot size, and a bid-side aggregate value, is displayed such that it is essentially a mirror image of the ask-side entry.

One or more of the following features may also be included. Displaying an ask-side entry includes simultaneously displaying multiple ask-side entries in an ask-side table. Displaying an ask-side entry includes sorting the multiple ask-side entries in accordance with a user-defined sorting parameter. The ask-side aggregate value is generated for a specific ask-side entry. This ask-side aggregate value is equal to the lot size of that specific ask-side entry summed with the lot sizes of all preceding ask-side entries included in the ask-side table. Displaying a bid-side entry includes simultaneously displaying multiple bid-side entries in a bid-side table. Displaying a bid-side entry includes sorting the multiple bid-side entries in accordance with a user-defined sorting parameter. The bid-side aggregate value is generated for a specific bid-side entry, such that the bid-side aggregate value is equal to the lot size of that specific bid-side entry summed with the lot sizes of all preceding bid-side entries included in the bid-side table. One of the displaying an ask-side entry and displaying a bid-side entry is deactivated.

According to a further aspect of this invention, a computer program product residing on a computer readable medium has a plurality of instructions stored on it. When these instructions are executed by the processor, they cause that processor to select a specific security traded on a securities market. A desired price range for the specific security is specified. An ask-side entry is displayed, in a multi-column format, for the specific security that is offered for sale by at least one market participant on the securities market, such that the ask-side entry includes an ask price, a lot size, and an ask-side aggregate value. A bid-side entry is displayed, in a multi- column format, for the specific security that is wanted for purchase by at least one market participant on the securities market. This bid-side entry, which includes a bid price, a lot size, and a bid-side aggregate value, is displayed such that it is essentially a mirror image of the ask-side entry.

One or more of the following features may also be included. Multiple ask-side entries are simultaneously displayed in an ask-side table. These multiple ask-side entries are sorted in accordance with a user-defined sorting parameter. The ask-side aggregate value is generated for a specific ask-side entry, such that the ask-side aggregate value is equal to the lot size of that specific ask-side entry summed with the lot sizes of all preceding ask-side entries included in the ask-side table.

Multiple bid-side entries are simultaneously displayed in a bid-side table. These multiple bid-side entries are sorted in accordance with a user-defined sorting parameter. The bid-side aggregate value is generated for a specific bid-side entry, such that the bid-side aggregate value is equal to the lot size of that specific bid-side entry summed with the lot sizes of all preceding bid-side entries included in the bid-side table.

One or more advantages can be provided from the above. The market participant can quickly and easily monitor all trading activity for a specific security. Additionally, by allowing the market participant to select the trading price range of the security they are monitoring, the summarized display can be filtered to remove the groups of the security that are outside of the market participant's price range. Further, by configuring the ask-side and bid-side of the display so that they are mirror images of each other, usability is increased due to easier readability and understandability.

### DESCRIPTION OF DRAWINGS

FIG. 1 is a diagrammatic view of a summary display process;

FIG. 2 is a diagrammatic view of the summarized display generated by the summary display process of FIG. 1; and

FIG. 3 is a diagrammatic view of a summary display method.

### DETAILED DESCRIPTION

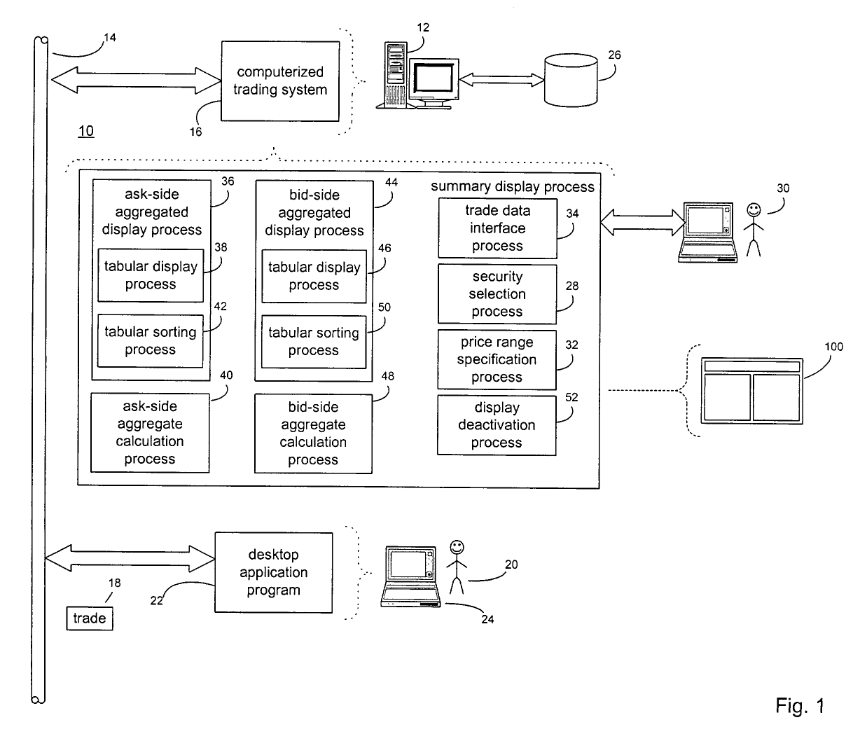

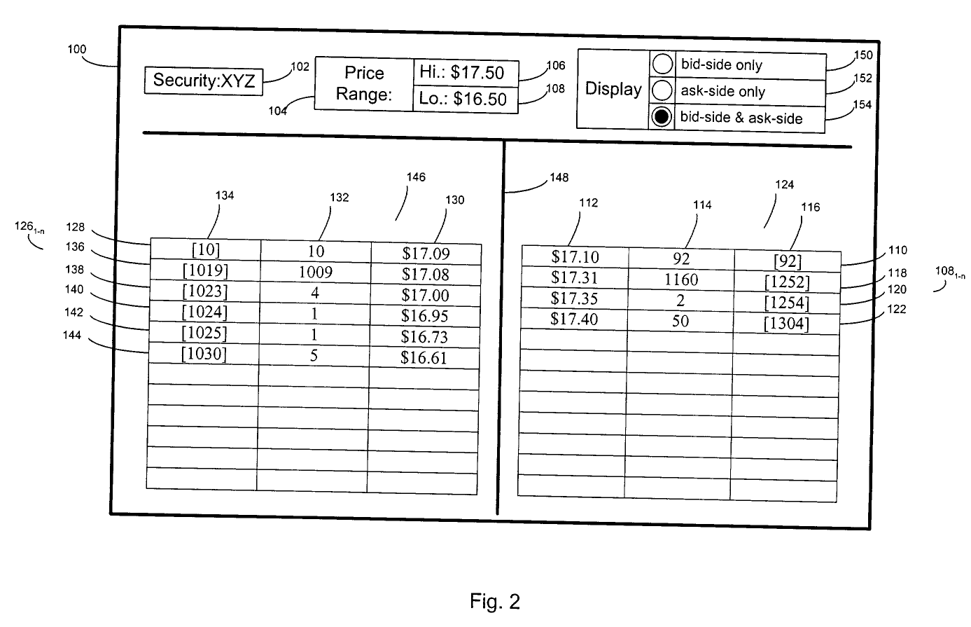

Referring to FIGS. 1 and 2, a summary display process 10 is shown. Summary display process 10 resides on server 12 that is connected to a distributed computing network 14 (e.g., the Internet, an intranet, a local area network, or some other form of network). Computerized trading system 16 trades securities electronically and resides on server 12, processes trades 18 entered by market participant 20. Market participant 20 typically accesses and uses computerized trading system 16 via a desktop application 22 (e.g., Microsoft Internet Explorer™, Netscape Navigator™, the Nasdaq Workstation II™, a specialized desktop interface, etc.) residing on a computer 24, thus allowing market participant 20 to trade securities with other market participants (not shown).

Summary display process 10 allows market participant 20 to monitor the trading activity for a specific security traded on computerized trading system 16 within a specified price range, and provides market participant 20 with a summarized display 100 (to be discussed below in greater detail) viewable on a display attached to computer 24. Typically, summarized display 100 is one screen in size, thus allowing market participant 20 to quickly get an overview of the activity of the specific security without having to scroll through or toggle between multiple screens.

Process 10 typically resides on a storage device 26 connected to server 12. Storage device 26 can be a hard disk drive, a tape drive, an optical drive, a RAID array, a random access memory (RAM), or a read-only memory (ROM), for example. Additionally, computerized trading system 16 stores all information relating to securities trades on storage device 26.

Process 10 includes a security selection process 28 that allows market participant 20 to select the specific security 102 they wish to monitor. This selection may occur is several different ways and will vary depending on the manner in which process 28 is implemented and configured by administrator 30. For example, market participant 20 may select the security they wish to monitor via a drop-down menu that allows the market participant to scroll through a list of securities. This drop down menu may use ticker symbols or may list the full name of the issuer of the security. Alternatively, market participant 20 may enter the security's ticker symbol directly, thus allowing for quicker selection.

Process 10 also includes a price range specification process 32 that allows market participant 20 to select a desired price range 104 for the specific security 102 they wish to monitor (i.e., the security that market participant 20 selected with security selection process 28).

Generally when securities are traded, outstanding offers to sell the security will have a higher price then outstanding bids to buy the security. Once the price of the bid to buy is equal to the price of the offer to sell, a trade of the security occurs. For example, if Market participant A wishes to sell one share of XYZ corp. for $10 but Market participant B, who wants to purchase one share of XYZ corp., is only willing to pay $9 for it, a trade of this security will not occur until: (a) Market participant A lowers their offer price to $9, (b) Market participant B raises their bid price to $10, or (c) the two market participants meet somewhere in the middle. Further, as there are typically multiple sellers, these sellers tend to offer their shares at different prices. Additionally, as there are also multiple buyers, these buyers tend to wish to purchase shares at different prices. Therefore, concerning a specific security, there is typically a wide range of prices that span from the very low bid to buy, through the actual trading value, and right up to the very high offer to sell.

Price range specification process 32 allows market participant 20 to define a price range for the specific security they wish to monitor. This price range selection may occur is several different ways and will vary depending on the manner in which process 32 is implemented and configured by administrator 30. For example, market participant 20 may select the price range of securities to monitor via a drop-down menu that allows the market participant to scroll through a list of price ranges and select the range to monitor. Alternatively, market participant 20 may manually enter an upper limit 106 and a lower limit 108. Additionally, market participant 20 may enter a specific price (e.g., $10). Therefore, for this example, the range would be a fixed dollar amount in which the upper limit 106 is equal to the lower limit 108. Further, market participant 20 may enter a wildcard descriptor (e.g., *) for either or both limits. Therefore, the range could be from negative infinity to positive infinity, resulting in all shares of the selected security being displayed (regardless of their offer/bid price). The use of price range specification process 32 by market participant 20 results in summarized display 100 being filtered to remove any shares of the specific security 102 that fall outside of the desired price range 104 selected by market participant 20.

Once a security 102 is selected and a desired price range 104 is specified, a trade data interface process 34 retrieves, from storage device 26 of server 12, the relevant trade data concerning the security selected by market participant 20. Typically, summarized display 100 is a real-time display, in that the information shown within the display is regularly updated (at a frequency defined by administrator 30) so that it is always accurate and up to date. Accordingly, trade data interface process 34 typically establishes a connection (i.e., a socket) with computerized trading system 16 so that the information provided in display 100 is always relevant and up-to-date.

Once a connection is established by trade data interface process 34 and the relevant trade data is retrieved, summarized display 100 is generated. An ask-side aggregated display process 36 displays, in a multi-column format, ask-side entries 108₁₋ₙ for the security that was selected by market participant 20, and is currently being traded on computerized trading system 16 in the desired price range 104 selected by market participant 20. Each discrete ask-side entry 108₁₋ₙ represents a discrete group of the specific security 102 selected by market participant 20, such that these groups of securities are being offered for sale by another market participant or group of market participants at a common price that is within the desired price range 104 specified by market participant 20. For example, assume that the security selection process 28 is configured to select XYZ corp. as the specific security 102 to monitor. Further, assume that market participant 20 used price range specification process 32 to enter a desired price range 104 of $16.50 (lower limit 108) to $17.50 (upper limit 106). Summarized display 100 would be populated with ask-side entries 108₁₋ₙ that met the criteria specified by market participant 20.

Ask-side entry 110 concerns a group of ninety-two shares of the security XYZ corp. that is currently being offered for sale. Ask-side entry 110 includes multiple columns, each of which provides information concerning the discrete group of securities being offered for sale, such as an ask price 112 (i.e., the price requested by the market participant(s) for one share of XYZ corp.), a lot size 114 (i.e., the quantity of shares of the selected security available at that ask price from those market participants(s)), and an aggregate value 116 (i.e., the total sum of shares available at the ask price or lower).

Ask-side aggregated display process 36 includes a tabular display process 38 for simultaneously displaying multiple ask-side entries (e.g., ask-side entries 110, 118, 120, 122). These ask-side entries are arranged vertically so that the ask price, lot size, and aggregate value of each entry are aligned, forming ask-side table 124.

For this particular summarized display 100, if market participant 20 is willing to pay up to $17.10 for a share of XYZ corp., market participant 20 could buy up to ninety-two shares for that price. This is shown in ask-side entry 110. However, if market participant 20 desires a ninety-third share of XYZ corp., market participant 20 will have to pay $17.31 for that one additional share (see ask-side entry 118), since there are only ninety-two shares of XYZ corp. for sale at $17.10. If market participant 20 wants to purchase additional shares of XYZ corp., they can purchase up to eleven-hundred-sixty shares for $17.31 per share (see ask-side entry 118 in FIG. 2).

Ask-side entries 110, 118, 120, 122 do not necessarily represent the shares available for a certain price from a single market participant. Conversely, the individual ask-side entries represent the combined total number of shares available of a specific security 102 for a specific asking price. Therefore, this combined total number of shares may be offered for sale by a single market participant or a group of market participants.

For example, assume that the total groups of shares of XYZ corp. offered for sale by the individual market participants trading on computerized trading system 16 are as follows:

| | Ask Price | Aggregate Value | Lot Size | Market Participant |
|---|---|---|---|---|
| Offer 1 | $17.10 | [92] | 92 | D |
| Offer 2 | $17.31 | [142] | 50 | M |
| Offer 3 | $17.31 | [253] | 111 | H |
| Offer 4 | $17.31 | [1252] | 999 | Y |
| Offer 5 | $17.35 | [1253] | 1 | Z |
| Offer 6 | $17.35 | [1254] | 1 | E |
| Offer 7 | $17.40 | [1304] | 50 | B |
| Offer 8 | $18.09 | [1305] | 1 | C |
| Offer 9 | $18.09 | [1309] | 4 | A |
| Offer 10 | $18.11 | [1310] | 1 | U |
| Offer 11 | $18.12 | [1311] | 1 | G |
| Offer 12 | $18.13 | [1312] | 1 | K |

As shown above, there are three market participants (namely Market participant M, Market participant H, and Market participant Y) that are offering shares of XYZ corp. for $17.31 per share. The combined number of shares of XYZ corp. offered by these three market participants for $17.31 is [50+111+999] for a total of eleven-hundred-sixty shares. These three separate and distinct offers (i.e., Offer 2, Offer 3, and Offer 4) are represented by ask-side entry 118. Further, Offer 1 is represented by ask-side entry 110, Offer 5 and Offer 6 are represented by ask-side entry 120, and Offer 7 is represented by ask-side entry 122. Further, notice that Offers 8-12 are not represented in ask-side table 124, as they are greater than the upper limit 106 of desired price range 104.

Process 10 includes an ask-side aggregate calculation process 40 for calculating the ask-side aggregate value 116 for each ask-side entry. Ask-side aggregate calculation process 40 determines the ask-side aggregate value 116 for a particular ask-side entry by summing the value of the lot size for that particular ask-side entry with the lot sizes of all preceding ask-side entries included in ask-side table 124. For example, the aggregate value for ask-side entry 110 is [92], the aggregate value for ask-side entry 118 is [1252, i.e., 92+1160], the aggregate value for ask-side entry 120 is [1254, i.e., 92+1160+2], and so forth.

A tabular sorting process 42 sorts ask-side entries (e.g., 110, 118, 120, 122) in accordance with a user-defined sorting parameter, such as ascending or descending ask prices, ascending or descending lot sizes, for example. This enables market participant 20 to group and order the ask-side entries within ask-side table 124 in accordance with their personal preferences. However, the ask-side entries within ask-side table 124 are typically sorted by ask price (as shown in FIG. 2).

In a manner similar to ask-side aggregated display process 36, a bid-side aggregated display process 44 displays, in a multi-column format, bid-side entries 126₁₋ₙ for the same security (i.e., XYZ corp.) that was selected by market participant 20 and is currently being traded on computerized trading system 16 for a common price that is in the desired price range 104 selected by market participant 20. Each discrete bid-side entry 126₁₋ₙ represents a discrete group of the specific security 102 selected by market participant 20 that is wanted for purchase by another market participant or group of market participants of computerized trading system 16. For example, bid-side entry 128 concerns a group of ten shares of the security XYZ corp. that a market participant or group of market participants currently wants to purchase for $17.09 per share. Similar to an ask-side entry, a bid-side entry includes multiple columns, each of which provides information concerning the discrete group of securities wanted for purchase, such as a bid price 130 (i.e., the price that the market participant(s) would like to pay for one share of XYZ corp.), a lot size 132 (i.e., the quantity of shares of the selected security that the market participant(s) want to purchase at that bid price), and an aggregate value 134 (i.e., the total sum of shares wanted for purchase at that bid price or higher).

Bid-side aggregated display process 44 includes a tabular display process 46 for simultaneously displaying multiple bid-side entries (e.g., bid-side entries 128, 136, 138, 140, 142, 144). These bid-side entries are arranged vertically so that the bid price, lot size, and aggregate value of each entry are aligned, forming an bid-side table 146.

Therefore, for this particular summarized display 100, if market participant 20 owns two-thousand shares of XYZ corp. that they are willing to sell for no less than $17.09 per share, market participant 20 can only sell ten shares, as bid-side entry 128 specifies that only ten shares of XYZ corp. are sought at $17.09 per share. However, if market participant 20 is willing to lower their sell price to $17.08 per share, the market participant can sell one-thousand-nineteen shares of XYZ corp. at that price (i.e., $17.08) or better. Specifically, ten shares can be sold for $17.09 per share (see bid-side entry 128) and one-thousand-nine shares can be sold for $17.08 per share (see bid-side entry 136), for a total of one-thousand-nineteen shares.

Again, bid-side entries 128, 136, 138, 140, 142, 144 do not necessarily represent the shares sought for purchase by a single market participant at a certain price. Conversely, the individual bid-side entries represent the combined total number of shares sought for purchase at a certain price, regardless of the market participant(s) wishing to make the purchase. Therefore, this combined total number of shares may be sought by a single market participant or a group of market participants.

For example, assume that the total groups of shares of XYZ corp. sought for purchase by the individual market participants trading on computerized trading system 16 are as follows:

| | Bid Price | Aggregate Value | Lot Size | Market Participant |
|---|---|---|---|---|
| Bid 1 | $17.09 | [10] | 10 | A |
| Bid 2 | $17.08 | [20] | 10 | C |
| Bid 3 | $17.08 | [1019] | 999 | L |
| Bid 4 | $17.00 | [1020] | 1 | G |
| Bid 5 | $17.00 | [1021] | 1 | Z |
| Bid 6 | $17.00 | [1022] | 1 | M |
| Bid 7 | $17.00 | [1023] | 1 | R |
| Bid 8 | $16.95 | [1024] | 1 | A |
| Bid 9 | $16.73 | [1025] | 1 | L |
| Bid 10 | $16.61 | [1030] | 5 | Q |
| Bid 11 | $16.44 | [1031] | 1 | Z |
| Bid 12 | $16.11 | [1036] | 5 | P |

Two market participants (namely Market participant C, and Market participant L) are bidding $17.08 per share for shares of XYZ corp.. The combined number of shares of XYZ corp. sought by these two market participants at $17.08 per share is [10+999] for a total of one-thousand-nine shares. These two separate and distinct bids (i.e., Bid 2, and Bid 3) are represented by bid-side entry 136. Further, Bid 1 is represented by bid-side entry 128; Bid 4, Bid 5, Bid 6, and Bid 7 are represented by bid-side entry 138; Bid 8 is represented by bid-side entry 140; Bid 9 is represented by bid-side entry 142; and Bid 10 is represented by bid-side entry 144. Bids 11-12 are not represented in bid-side table 146, as they are less than the lower limit 108 of desired price range 104.

Process 10 includes a bid-side aggregate calculation process 48 for calculating the bid-side aggregate value 134 for each bid-side entry. As with ask-side aggregate calculation process 40, bid-side aggregate calculation process 48 determines the bid-side aggregate value 134 for a particular bid-side entry by summing the value of the lot size for that particular bid-side entry with the lot sizes of all preceding bid-side entries included in bid-side table 146. For example, the aggregate value for bid-side entry 128 is [10], the aggregate value for bid-side entry 136 is [1019, i.e., 10+1009], the aggregate value for bid-side entry 138 is [1023, i.e., 10+1009+4], and so forth.

Similar to that of ask-side entries, a tabular sorting process 50 sorts bid-side entries (e.g., 128, 136, 138, 140, 142, 144) in accordance with a user-defined sorting parameter, such as ascending or descending bid prices, ascending or descending lot sizes, etc. This enables market participant 20 to group and order the bid-side entries within bid-side table 146 in accordance with their personal preferences. Again, like ask-side table 124, bid-side entries within bid-side table 146 are typically sorted by bid price (as shown in FIG. 2).

Bid-side aggregated display process 44 displays bid-side entries so that bid-side table 146 is essentially a mirror image of ask-side table 124. Specifically, the columns in bid-side table 146 are arranged in a fashion so that they are in the opposite order (i.e., when moving across the tables 124, 146 in a common direction) to that of ask-side table 124. The columns of these tables are essentially mirrored around an imaginary centerline 148. Column 112 and column 130 (i.e., ask prices and bid prices respectively) are the closest columns to centerline 148, whereas column 114 and column 132 (i.e., ask-side and bid-side lot sizes respectively) are the second closest columns to centerline 148, and so forth.

Process 10 includes a display deactivation process 52 that allows market participant 20 to control the content of summarized display 100. Specifically, display deactivation process 52 allows market participant 20 to selectively deactivate either ask-side aggregated display process 36 or bid-side aggregated display process 44. Therefore, if market participant 20 is only interested in buying shares of XYZ corp., the market participant deactivates bid-side aggregated display process 44. Alternatively, if market participant 20 is only interested in selling shares of XYZ corp., the market participant deactivates ask-side aggregated display process 36. Typically, market participant 20 makes this selection (concerning what is to be deactivated) on summarized display 100. Summarized display 100 may include check boxes 150, 152, 154 that allow market participant 20 to display “bid-side only” (i.e., ask-side deactivated), “ask-side only” (i.e., bid side deactivated), or “bid-side & ask-side” (i.e., neither deactivated). Alternatively, a drop down menu (not shown) may be included to allow the market participant to select which (if any) process is deactivated.

While the lot sizes 114, 132 described above are stated to be in units of shares, it is possible for these numbers to also represent groups of one-hundred shares (commonly referred to as “round lots”), or any other amount of shares. In this scenario, ask-side entry 110 may represent an offer to sell ninety-two-hundred shares of XYZ corp.

Centerline 148 may be a horizontal centerline, such that ask-side and bid-side entries are arranged in multi-row format and, therefore, mirroring occurs about a horizontal axis.

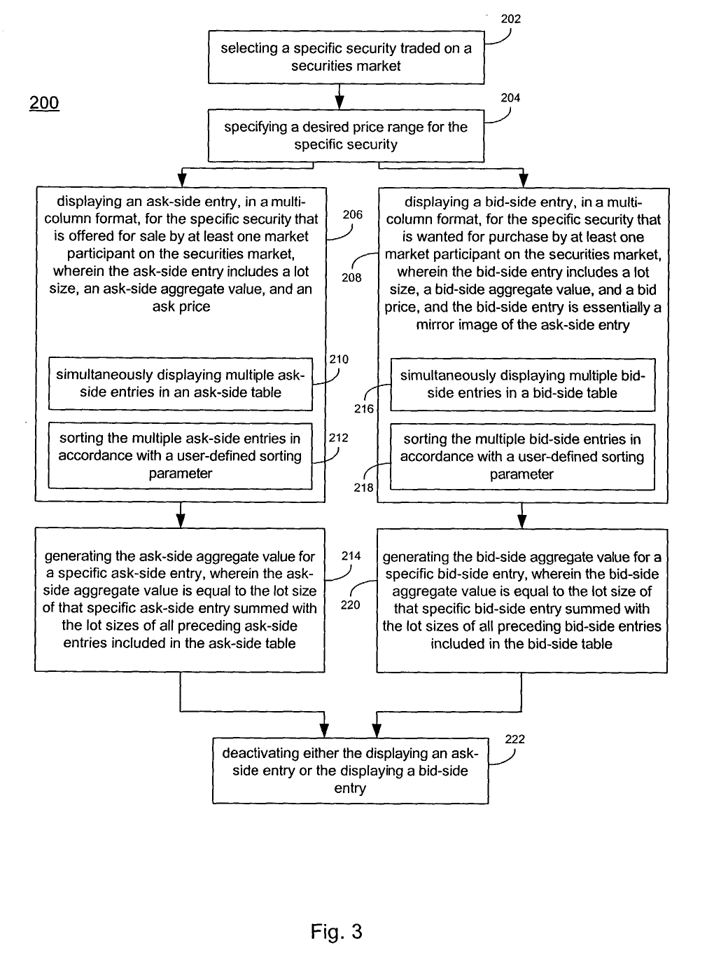

Referring to FIG. 3, there is shown a summary display method 200. A specific security traded on a securities market is selected 202 by a market participant. Further, that market participant specifies 204 the desired price range for that specific security. An ask-side entry is displayed 206, in a multi-column format, for the specific security that is offered for sale by at least one market participant on the securities market. This ask-side entry includes a lot size, and an ask price. A bid-side entry is displayed 208, in a multi-column format, for the specific security that is wanted for purchase by at least one market participant on a securities market. This bid-side entry, which includes a lot size, and a bid price, is essentially a mirror image of the ask-side entry.

Displaying 206 the ask-side entry includes simultaneously displaying 210 multiple ask-side entries in an ask-side table and sorting 212 these multiple ask-side entries in accordance with a user-defined sorting parameter. An ask-side aggregate value is generated 214 for a specific ask-side entry, such that the ask-side aggregate value is equal to the lot size of that specific ask-side entry summed with the lot sizes of all preceding ask-side entries included in the ask-side table.

Displaying 208 a bid-side entry includes simultaneously displaying 216 multiple bid-side entries in a bid-side table and sorting 218 these multiple bid-side entries in accordance with a user-defined sorting parameter. A bid-side aggregate value is generated 220 for a specific bid-side entry, such that the bid-side aggregate value is equal to the lot size of that specific bid-side entry summed with the lot sizes of all preceding bid-side entries included in the bid-side table.

A market participant may selectively deactivate 222 either displaying 206 an ask-side entry or displaying 208 a bid-side entry.

The system described herein is not limited to the hardware embodiment described above; it may find applicability in any computing or processing environment. The system may be implemented in hardware, software, or a combination of the two. For example, the system may be implemented using circuitry, such as one or more of programmable logic (e.g., an ASIC), logic gates, a processor, and a memory.

The system may be implemented in computer programs executing on programmable computers that each includes a processor and a storage medium readable by the processor (including volatile and non-volatile memory and/or storage elements). Each such program may be implemented in a high-level procedural or object-oriented programming language to communicate with a computer system. However, the programs can be implemented in assembly or machine language. The language may be a compiled or an interpreted language.

Each computer program may be stored on an article of manufacture, such as a storage medium (e.g., CD-ROM, hard disk, or magnetic diskette) or device (e.g., computer peripheral), that is readable by a general or special purpose programmable computer for configuring and operating the computer when the storage medium or device is read by the computer to perform the functions of the data framer interface. The system may also be implemented as a machine-readable storage medium, configured with a computer program, where, upon execution, instructions in the computer program cause a machine to operate to perform the functions of the system described above.

Embodiments of the system may be used in a variety of applications. Although the system is not limited in this respect, the system may be implemented with memory devices in microcontrollers, general purpose microprocessors, digital signal processors (DSPs), reduced instruction-set computing (RISC), and complex instruction-set computing (CISC), among other electronic components.

Embodiments of the system may also be implemented using integrated circuit blocks referred to as main memory, cache memory, or other types of memory that store electronic instructions to be executed by a microprocessor or store data that may be used in arithmetic operations.

A number of embodiments of the invention have been described. Nevertheless, it will be understood that various modifications may be made without departing from the spirit and scope of the invention.

What is claimed is:

1. A summary display process comprising:
a security selection process for selecting a specific security traded on a securities market;
a price range specification process for specifying a desired price range for said specific security;
an ask-side aggregated display process for displaying, in a multi-column format, an ask-side entry for said specific security that is offered for sale by at least one market participant on said securities market, wherein said ask-side entry includes an ask price, a lot size, and an ask-side aggregate value; and
a bid-side aggregated display process for displaying, in a multi-column format, a bid-side entry for said specific security that is wanted for purchase by at least one market participant on said securities market, wherein said bid-side entry includes a bid price, a lot size, and a bid-side aggregate value;
wherein said bid-side aggregated display process is configured to display said bid-side entry such that it is essentially a mirror image of said ask-side entry.

2. The summary display process of claim 1 wherein said ask-side aggregated display process includes a tabular display process for simultaneously displaying multiple ask-side entries in an ask-side table.

3. The summary display process of claim 2 wherein said ask-side aggregated display process includes a tabular sorting process for sorting said multiple ask-side entries in accordance with a user-defined sorting parameter.

4. The summary display process of claim 3 wherein said user-defined sorting parameter is chosen for the group consisting of: said lot size; and said ask price.

5. The summary display process of claim 2 further comprising an ask-side aggregate calculation process for generating said ask-side aggregate value for a specific ask-side entry, wherein said ask-side aggregate value is equal to the lot size of said specific ask-side entry summed with the lot sizes of all preceding ask-side entries included in said ask-side table.

6. The summary display process of claim 1 wherein said bid-side aggregated display process includes a tabular display process for simultaneously displaying multiple bid-side entries in a bid-side table.

7. The summary display process of claim 6 wherein said bid-side aggregated display process includes a tabular sorting process for sorting said multiple bid-side entries in accordance with a user-defined sorting parameter.

8. The summary display process of claim 7 wherein said user-defined sorting parameter is chosen for the group consisting of: said lot size; and said bid price.

9. The summary display process of claim 6 further comprising a bid-side aggregate calculation process for generating said bid-side aggregate value for a specific bid-side entry, wherein said bid-side aggregate value is equal to the lot size of said specific bid-side entry summed with the lot sizes of all preceding bid-side entries included in said bid-side table.

10. The summary display process of claim 1 further comprising a display deactivation process for deactivating one of said ask-side aggregated display process and said bid-side aggregated display process.

11. A summary display method comprising:
selecting a specific security traded on a securities market;
specifying a desired price range for the specific security;
displaying an ask-side entry, in a multi-column format, for the specific security that is offered for sale by at least one market participant on the securities market, wherein the ask-side entry includes an ask price, a lot size, and an ask-side aggregate value; and
displaying a bid-side entry, in a multi-column format, for the specific security that is wanted for purchase by at least one market participant on the securities market, wherein the bid-side entry includes a bid price, a lot size, and a bid-side aggregate value, wherein the bid-side entry is displayed such that it is essentially a mirror image of the ask-side entry.

12. The summary display method of claim 11 wherein said displaying an ask-side entry includes simultaneously displaying multiple ask-side entries in an ask-side table.

13. The summary display method of claim 12 wherein said displaying an ask-side entry includes sorting the multiple ask-side entries in-accordance with a user-defined sorting parameter.

14. The summary display method of claim 12 further comprising generating the ask-side aggregate value for a specific ask-side entry, wherein the ask-side aggregate value is equal to the lot size of that specific ask-side entry summed with the lot sizes of all preceding ask-side entries included in the ask-side table.

15. The summary display method of claim 11 wherein said displaying a bid-side entry includes simultaneously displaying multiple bid-side entries in a bid-side table.

16. The summary display method of claim 15 wherein said displaying a bid-side entry includes sorting the multiple bid-side entries in accordance with a user-defined sorting parameter.

17. The summary display method of claim 15 further comprising generating the bid-side aggregate value for a specific bid-side entry, wherein the bid-side aggregate value is equal to the lot size of that specific bid-side entry summed with the lot sizes of all preceding bid-side entries included in the bid-side table.

18. The summary display method of claim 11 further comprising deactivating one of said displaying an ask-side entry and displaying a bid-side entry.

19. A computer program product residing on a computer readable medium having a plurality of instructions stored thereon which, when executed by the processor, cause that processor to:
select a specific security traded on a securities market;
specify a desired price range for the specific security;
display an ask-side entry, in a multi-column format, for the specific security that is offered for sale by at least one market participant on the securities market, wherein the ask-side entry includes an ask price, a lot size, and an ask-side aggregate value; and
display a bid-side entry, in a multi-column format, for the specific security that is wanted for purchase by at least one market participant on the securities market, wherein the bid-side entry includes a bid price, a lot size, and a bid-side aggregate value, wherein the bid-side entry is displayed such that it is essentially a mirror image of the ask-side entry.

20. The computer program product of claim 19 wherein said plurality of instructions further cause the processor to simultaneously display multiple ask-side entries in an ask-side table.

21. The computer program product of claim 20 wherein said plurality of instructions further cause the processor to sort the multiple ask-side entries in accordance with a user-defined sorting parameter.

22. The computer program product of claim 20 wherein said plurality of instructions further cause the processor to generate the ask-side -aggregate value for a specific ask-side entry, wherein the ask-side aggregate value is equal to the lot size of that specific ask-side entry summed with the lot sizes of all preceding ask-side entries included in the ask-side table.

23. The computer program product of claim 19 wherein said plurality of instructions further cause the processor to simultaneously display multiple bid-side entries in a bid-side table.

24. The computer program product of claim 23 wherein said plurality of instructions further cause the processor to sort the multiple bid-side entries in accordance with a user-defined sorting parameter.

25. The computer program product of claim 19 wherein said plurality of instructions further cause the processor to generate the bid-side aggregate value for a specific bid-side entry, wherein the bid-side aggregate value is equal to the lot size of that specific bid-side entry summed with the lot sizes of all preceding bid-side entries included in the bid-side table.
